(19) United States
(12) Patent Application Publication
(10) Pub. No.: US 2015/0000485 A1
(43) Pub. Date: Jan. 1, 2015

(54) Apparatus and Methods for Perforating Leather Using Perforation Tiles

(71) Applicant: Ontario Die International Incorporated, Kitchener (CA)

(72) Inventors: Petr Piro, Kitchener (CA); Wesley Elton Scott, Kitchener (CA)

(73) Assignee: Ontario Die International Incorporated, Kitchener, ON (CA)

(21) Appl. No.: 14/368,132

(22) PCT Filed: Dec. 21, 2012
(86) PCT No.: PCT/CA2012/001178

§ 371 Date: Jun. 23, 2014

Related U.S. Application Data
(60) Provisional application No. 61/579,885, filed on Dec. 23, 2011.

(51) Int. Cl. B26F 1/14; C14B 5/00; C14B 5/02; B26F 1/02

(52) U.S. Cl. CPC B26F 1/14; B26F 1/02; C14B 5/00; C14B 5/02
USPC 83/30; 83/691; 83/164; 83/687

(57) ABSTRACT

According to some aspects disclosed herein, there is an apparatus for perforating a sheet of material. The apparatus includes a tile holder and a plurality of perforation tiles removably mountable to the tile holder. Each perforation tile includes a fastener plate for removably mounting the perforation tile to the tile holder; a punch plate supported by the fastener plate opposite the tile holder, the punch plate having at least one aperture therein; and at least one punch received in the at least one aperture and extending outwardly beyond the punch plate away from the fastener plate for perforating the sheet of material.

### RELATED APPLICATIONS

This application claims the benefit of U.S. provisional application No. 61/579,885 filed Dec. 23, 2012, the entire contents of which are hereby incorporated by reference herein for all purposes.

### TECHNICAL FIELD

The embodiments herein relate to apparatus and methods for perforating sheets of material, and in particular to apparatus and methods of perforating sheets of leather using perforation dies.

### INTRODUCTION

Perforation dies are often used to perforate sheets of material, for example leather. Conventional perforation dies typically include a lower die shoe (or lower plate) having an array of upwardly extending punches that define a perforation pattern. In use, a sheet of material is placed on the punches of the lower plate and the sheet is pressed downward onto the punches, for example, using a roller press so as to perforate the sheet of material. A cutting pad is often placed between the sheet of material and the roller press.

These conventional perforation dies can be difficult and costly to manufacture. For example, it can be costly and time consuming to secure each punch to the lower plate. Furthermore, the lower plate may warp or stretch as each punch is installed. The accumulation of these distortions can cause alignment issues with other parts of the perforation die such as clearance plates that are positioned underneath the lower plate so as to eject cut material from the punches.

The difficulty and cost may become even greater for complex or detailed perforation patterns that include a large number of punches secured to the lower plate. Furthermore, a number of different perforation dies may be required for different perforation patterns. Accordingly, the cost of perforation dies can represent a significant expense.

Maintaining these perforation dies can also be costly. For example, if a punch in the lower plate breaks, the entire lower plate may need to be removed in order to replace the punch, which can result in extended production downtimes. Some manufacturers address this by purchasing back-up perforation dies for use while replacing a punch. However, the cost of these back-up perforation dies can substantially increase costs, which is generally undesirable.

### SUMMARY OF SOME EMBODIMENTS

According to some embodiments, there is provided an apparatus for perforating a sheet of material. The apparatus comprises a tile holder and a plurality of perforation tiles removably mountable to the tile holder. Each perforation tile includes a fastener plate for removably mounting the perforation tile to the tile holder; a punch plate supported by the fastener plate opposite the tile holder, the punch plate having at least one aperture therein; and at least one punch received in the at least one aperture and extending outwardly beyond the punch plate away from the fastener plate for perforating the sheet of material.

In some embodiments, each perforation tile may further include a backing plate positioned between the fastener plate and the punch plate for supporting the at least one punch.

In some embodiments, the tile holder may include a plurality of mounting apertures for removably mounting the plurality of perforation tiles to the tile holder. Furthermore, the fastener plate of each perforation tile may have a threaded aperture for receiving a corresponding threaded fastener so as to threadably fasten the perforation tile to the tile holder through one of the mounting apertures. Further still, each perforation tile may include a backing plate positioned between the fastener plate and the punch plate for supporting the at least one punch. The threaded aperture may extend entirely through the fastener plate.

In some embodiments, the tile holder may include a bolster plate and a tile receiving plate spaced apart from the bolster plate.

In some embodiments, each punch may have a tip portion with a cutting edge for perforating the sheet of material; a cutting aperture on the tip portion for receiving cut material; and an ejection port located on a side of the punch. The ejection port may be in communication with the cutting aperture for ejecting the cut material from the punch.

In some embodiments, the ejection port may be positioned and shaped to provide an ejection path that slopes downwardly away from the cutting aperture.

In some embodiments, the at least one punch may include a plurality of punches, and the ejection port may be positioned and shaped to provide an ejection path that extends laterally away from a nearest adjacent punch. Furthermore, the plurality of punches may be arranged in a matrix of rows and columns such that the nearest adjacent punch is an adjacent punch in a respective row. Further still, the ejection path of each punch may extend toward an angularly positioned punch that is offset from the respective punch by at least one row and at least one column.

In some embodiments, the apparatus may further comprise locating members for positioning and aligning the plurality of perforation tiles on the tile holder.

In some embodiments, the tile holder may include opposed peripheral edges, and the locating members may include a set of datum members along one peripheral edge, and a set of locking clamps along the opposing peripheral edge for selectively biasing the perforation tiles towards the opposing datum members. Furthermore, the locking clamps may include eccentric members rotatably mounted to the tile holder about an eccentric axis of rotation.

In some embodiments, the tile holder may include opposed peripheral edges, and the locating members may include a first alignment member mounted along one peripheral edge; a second alignment member mounted along the opposing peripheral edge; and at least one biasing member located between the first alignment member and at least one perforation tile for biasing the perforation tiles towards the second alignment member.

In some embodiments, the plurality of perforation tiles may be arrangeable on the tile holder to define a perforation pattern.

According to some embodiments, there is provided a perforation tile removably mountable to a tile holder for perforating a sheet of material. The perforation tile comprises a fastener plate for removably mounting the perforation tile to the tile holder; a punch plate supported by the fastener plate opposite the tile holder, the punch plate having at least one aperture therein; and at least one punch received in the at least one aperture and extending outwardly beyond the punch plate away from the fastener plate for perforating the sheet of material.

In some embodiments, the perforation tile may further comprise a backing plate positioned between the fastener plate and the punch plate for supporting the at least one punch. Furthermore, the fastener plate may have a threaded aperture for receiving a corresponding threaded fastener so as to threadably fasten the perforation tile to the tile holder.

According to some embodiments, there is provided a method of perforating a sheet of material. The method comprises selecting a plurality of perforation tiles having a at least one punch for perforating the sheet of material; mounting the selected perforation tiles to a tile holder; placing the sheet of material over the mounted perforation tiles; and pressing the sheet of material onto the mounted perforation tiles so as to perforate the sheet of material.

In some embodiments, the method may further comprise arranging the selected perforation tiles on the tile holder such that the plurality of perforation tiles define a perforation pattern, and pressing the sheet of material onto the mounted perforation tiles may perforate the sheet of material with the perforation pattern.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an apparatus for perforating a sheet of material according to one embodiment;

FIG. 2 is a cross-sectional view of the apparatus of FIG. 1 taken along the line 2-2;

FIG. 3 is a perspective view of a tile holder of the apparatus of FIG. 1;

FIG. 4 is a bottom perspective view of a perforation tile that is removably mountable to the tile holder;

FIG. 5 is a top perspective view of the perforation tile of FIG. 4;

FIG. 6 is a cross-sectional elevation view of the perforation tile of FIG. 4 along the line 6-6;

FIG. 7 is a side elevation view of the perforation tile of FIG. 4;

FIG. 8 is a cross-sectional elevation view of a punch of the perforation tile of FIG. 4;

FIG. 9 is a top plan view of a portion of the apparatus of FIG. 1 showing a plurality of punches and an ejection path of a particular punch;

FIG. 10 is an enlarged view of a portion of the apparatus of FIG. 1 showing a set of datum members for positioning and aligning the perforation tiles on the tile holder;

FIG. 11 is an enlarged view of a portion of the apparatus of FIG. 1 showing a set of locking clamps for biasing the perforation tiles against opposing datum members of FIG. 10;

FIG. 12 is a perspective view of a plurality of perforation tiles arranged according to a first perforation pattern;

FIG. 13 is a perspective view of a plurality of perforation tiles arranged according to a second perforation pattern;

FIG. 14 is a flow chart illustrating a method of perforating a sheet of material according to some embodiments;

FIG. 15 is a perspective view of another apparatus for perforating a sheet of material according to another embodiment;

FIG. 16 is a cross-sectional view of the apparatus of FIG. 15; and

FIG. 17 is a cross-sectional view of another apparatus for perforating a sheet of material according to another embodiment.

### DETAILED DESCRIPTION OF SOME EMBODIMENTS

It will be appreciated that for simplicity and clarity of illustration, where appropriate, reference numerals may be repeated among the figures to indicate corresponding or analogous elements. In addition, numerous specific details are set forth in order to provide a thorough understanding of the example embodiments described. However, in some instances, well-known methods, procedures and components may not have been described in detail so as not to obscure some embodiments as described herein.

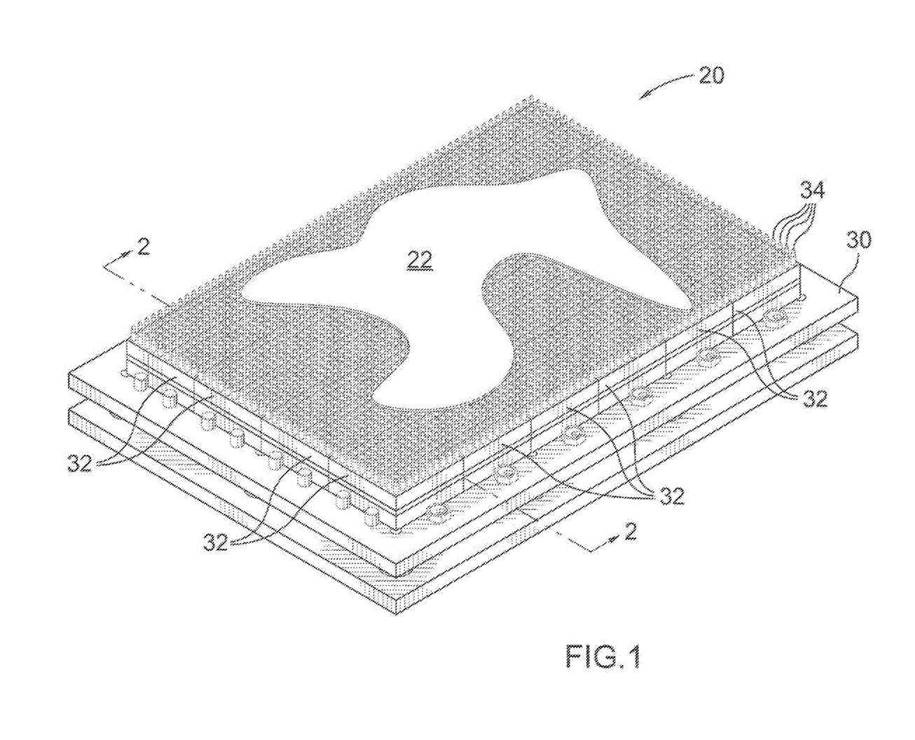

Referring now to FIG. 1, illustrated therein is an apparatus 20 for perforating a sheet of material 22, such as a sheet of leather, according to some embodiments. The apparatus 20 generally includes a tile holder 30 and a plurality of perforation tiles 32 removably mountable to the tile holder 30. As will be discussed further below, each perforation tile 32 includes one or more punches 34 for perforating the sheet of material 22.

In use, the sheet of material 22 is placed on top of the punches 34. The sheet of material 22 is then pressed downward so that the punches 34 perforate the sheet 22. For example, the sheet of material 22 may be pressed onto the punches 34 using a roller press or another press such as a platen press. In some examples, a cutting pad (not shown) may be positioned between the sheet of material 22 and the roller press. The cutting pad can protect the punches 34 from being damaged by the roller press while allowing the punches 34 to perforate the sheet of material 22. The cutting pad may be made of polypropylene, nylon, or another suitable material.

Referring generally to FIGS. 1-3, the tile holder 30 is sized and shaped to locate and support the perforation tiles 32 thereon. For example, as shown in FIG. 1, in this embodiment there are twenty-four perforation tiles 32 arranged in a 4×6 matrix on top of the tile holder 30. In other embodiments, other quantities of perforation tiles 32 (e.g. two or more) may be used, and the perforation tiles may have other arrangements on the tile holder 30 (e.g. 3×3, 8×8, and so on).

In some embodiments, the tile holder 30 may include a lower bolster plate 40 and an upper tile receiving plate 42 spaced apart from the bolster plate 40 (e.g. using spacers 44). The plates 40, 42 and spacers 44 may be secured together using fasteners 45, such as machine screws or bolts.

Spacing the plates 40, 42 apart in this manner can increase the relative bending resistance of the tile holder 30 (also known as the second moment of inertia), which can reduce movement, bending and flex of the tile holder 30 during use. This spaced apart configuration may also allow the tile holder 30 to be lighter than a single solid plate, which can make the tile holder 30 easier to handle (particularly when the tile holder is very large).

In other embodiments, the tile holder 30 may have other configurations. For example, while the illustrated embodiment includes two spaced apart plates 40, 42, in some embodiments the tile holder 30 may include more than two spaced apart plates. Furthermore, in some embodiments the tile holder 30 may include a single solid plate (for example, where the tile holder 30 has a relatively small size).

In some examples, the top of the tile receiving plate 42 and the bottom of the bolster plate 40 may be generally parallel, for example, to reduce waviness and unevenness. This may be achieved, for example, by grinding the respective surfaces after securing the plates 40, 42 together. Providing the parallel surfaces can provide a generally flat reference base for the perforation tiles, which may help ensure that each punch consistently perforates the sheet of material, particularly when applying pressure using a roller press.

As shown, the tile holder 30 includes a plurality of mounting apertures 46 for removably mounting the perforation tiles 32 to the tile holder 30. In particular, the perforation tiles 32 may be mounted to the tile holder 30 using fasteners 48 (e.g. threaded fasteners, such as machine screws or bolts) that extend through the mounting apertures 46.

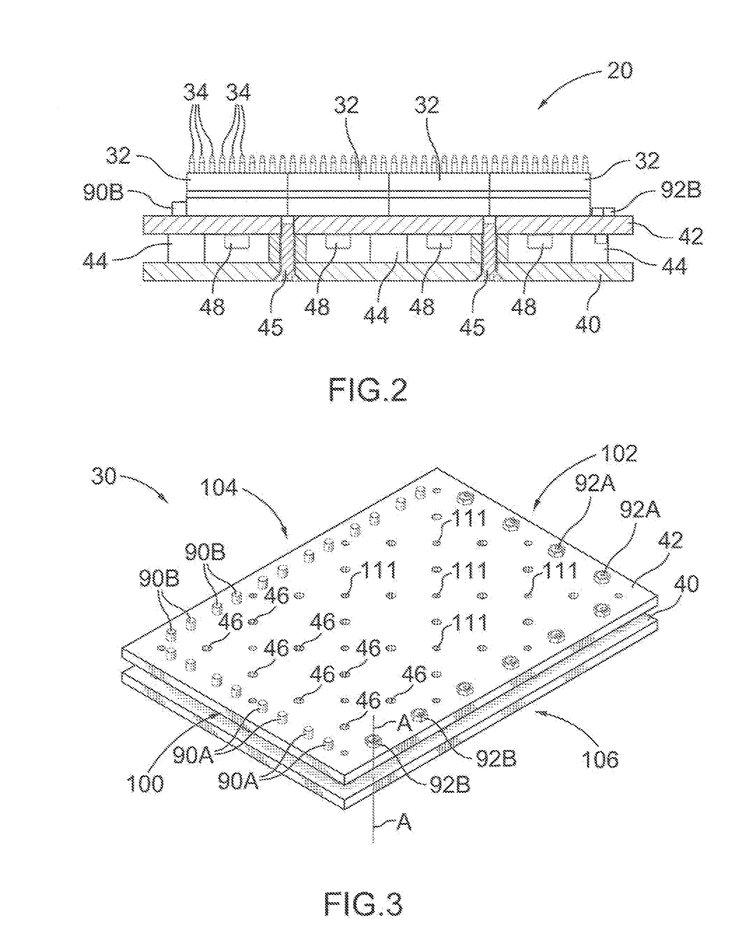

As shown in FIG. 2, in some embodiments the mounting apertures 46 may extend through the tile receiving plate 42, but not through the lower bolster plate 40. Accordingly, the threaded fasteners 48 will only extend through the tile receiving plate 42, and the heads of the threaded fasteners 48 will be positioned between the plates 40, 42 (as shown in FIG. 2). This allows the bottom surface of the bolster plate 40 to remain flat and undisturbed by the fasteners 48.

In other embodiments, the threaded fasteners 48 may extend through both plates 40, 42.

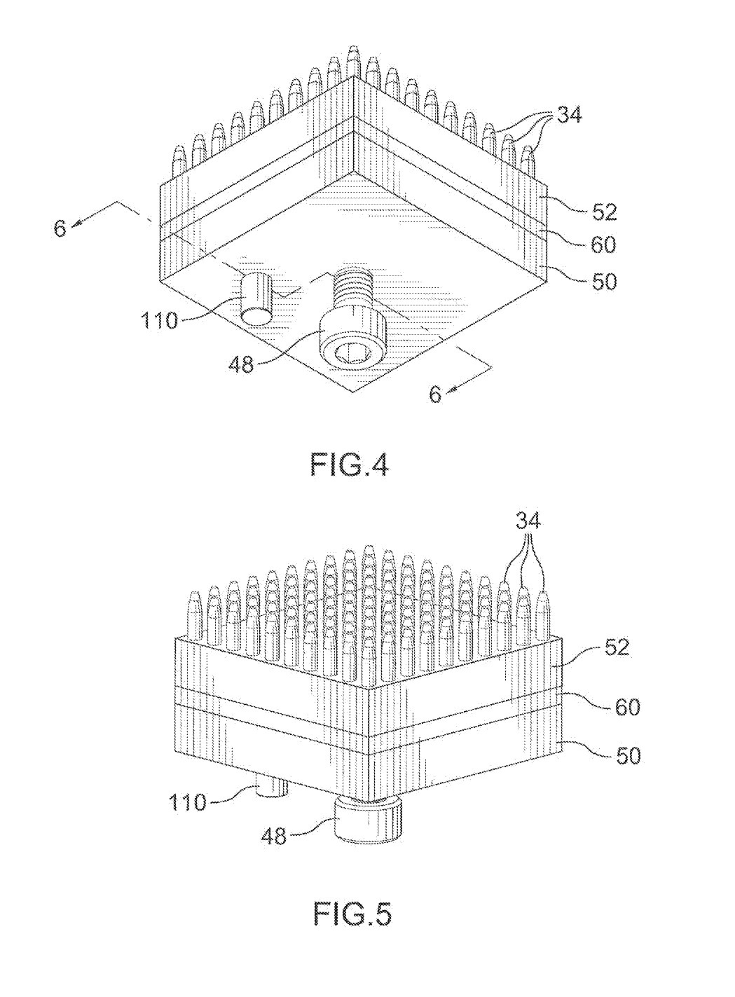

Referring now generally to FIGS. 4-7, each perforation tile 32 in this embodiment includes a fastener plate 50 and a punch plate 52.

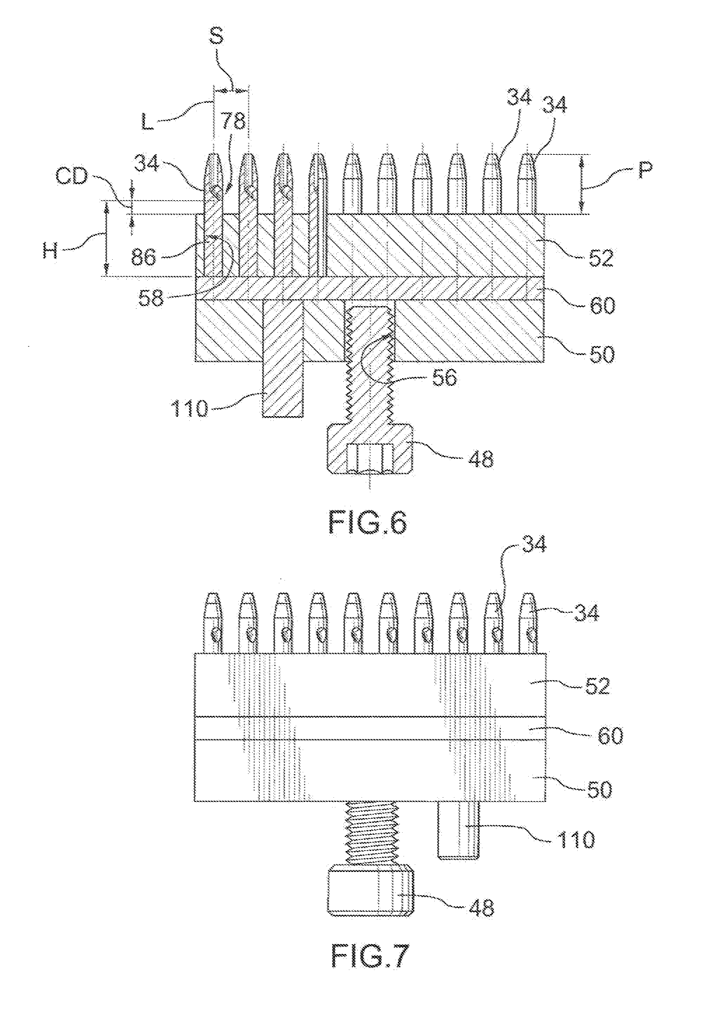

The fastener plate 50 is generally adapted to allow for removable mounting of the perforation tile 32 to the tile holder 30. For example, as shown in FIG. 6, the fastener plate 50 may have a threaded aperture 56 for receiving one of the threaded fasteners 48 to secure the perforation tile 32 to the tile holder 30 using the mounting apertures 46.

In other embodiments, the fastener plate 50 may be removably mounted to the tile holder 30 using other techniques, for example, using magnets, locking clips, cable tie-downs, tongue-in-groove slide connections, and so on.

The punch plate 52 is generally supported by the fastener plate 50 opposite to the tile holder 30. As shown in FIG. 6, the punch plate 52 has a plurality of apertures 58 therein for receiving the punches 34. The punches 34 extend outwardly beyond the punch plate 52, generally away from the fastener plate 50. As shown, each punch 34 may extend along a respective longitudinal axis L and may have a punch height P that extends beyond the punch plate 52.

The punches 34 may be secured to the punch plate 52 using a press fit or an interference fit. For example, the outer diameter of the punch 34 may be selected to be slightly larger than the apertures 58 in the punch plate 52 so that frictional forces securely hold the punches 34 within the apertures 58. In some embodiments, the punches 34 may be secured to the punch plate 52 using other techniques, for example, by bonding the punches 34 to the punch plate 52 using adhesive (e.g. Loctite™ 680) or welds.

As shown, in some embodiments each perforation tile 32 may include a backing plate 60 positioned between the fastener plate 50 and the punch plate 52. The backing plate 60 generally supports the punches 34, for example, to prevent the punches 34 from being pushed into the fastener plate 50. Accordingly, the backing plate 60 may be made from a high strength material, such as high carbon steel (e.g. tool steel). In contrast, the fastener plate 50 and punch plate 52 may be made from lower strength materials such as low carbon steel (e.g. mild steel).

The backing plate 60 may have an upper flat surface adjacent the punch plate 52. This upper flat surface serves as a reference plane for aligning the punches 34, so that the punch height P for each of the punches 34 is approximately the same. This may help provide a substantially flat cutting plane so that each punch 34 penetrates the sheet of material 22 and forms the desired perforations therein.

The backing plate 60 may also provide an end wall for the threaded aperture 56 in the fastener plate 50. For example, as shown in FIG. 6, the threaded aperture 56 may extend entirely through the fastener plate 50 and the backing plate 60 may provide a barrier between the threaded aperture 56 and the apertures 58 in the punch plate 52. Without the backing plate 60, punches 34 might otherwise be pushed through apertures 58 in the punch plate 52 and into the threaded aperture 56.

The fastener plate 50, punch plate 52 and backing plate 60 may be secured together in a number of ways, for example, using welds, threaded fasteners, adhesives (e.g. Loctite™ 330), and so on.

In some embodiments, the backing plate 60 may be omitted. In such embodiments, the fastener plate 50 may be made from a high strength material such as high carbon steel, and the fastener plate 50 may have an upper flat surface for aligning the punches 34. Furthermore, in such embodiments, the threaded aperture 56 may extend only partially through the fastener plate 50, for example, such that the threaded aperture 56 has an end wall. The end wall may provide a barrier between the threaded aperture 56 and the apertures 58 in the punch plate 52 so that punches 34 are not pushed through the apertures 58 and into the threaded aperture 56.

Generally, the use of a backing plate 60 may allow a thinner fastener plate 50, and may reduce the overall size of the perforation tile 32. For example, the threaded aperture 56 can be drilled and tapped entirely through the fastener plate 50, and the backing plate 60 can be placed over the threaded aperture 56. Furthermore, the combined thickness of the backing plate 60 and the fastener plate 50 may be thinner than a fastener plate 50 having a threaded aperture 56 that extends only partially therethrough. In particular, manufacturing limitations may necessitate a thicker fastener plate 50 when a backing plate 60 is not used due to clearance requirements and the fact that the threaded aperture will be drilled and tapped blind.

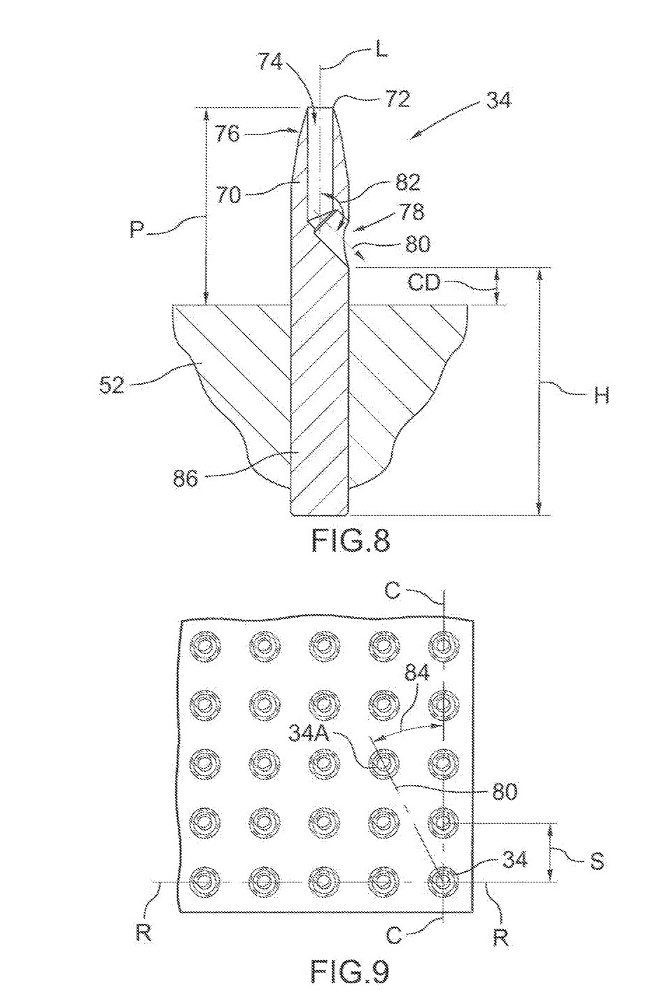

Referring now to FIG. 8, as shown each punch 34 extends upwardly to a punch height P. Each punch 34 may have a tip portion 70 with a cutting edge 72 for perforating the sheet 22, and a cutting aperture 74 on the tip portion 70 for receiving cut material. The cutting edge 72 is generally formed around the cutting aperture 74. In particular, the cutting aperture 74 may have a circular shape, and the cutting edge 72 may be a ring-shaped knife edge around the circular cutting aperture 74.

In other embodiments, the cutting edge 72 and the cutting aperture 74 may have other shapes, such as square, star-shaped, and so on.

In some examples, the cutting edge 72 may be located on a tubular portion 76 of the tip portion 70. For example, the tubular portion 76 may taper radially inward toward the cutting edge 72 to form a circular knife edge around the cutting aperture 74.

As shown, each punch 34 may also have an ejection port 78 located on a side of the punch 34. The ejection port 78 is in communication with the cutting aperture 74 and is adapted so that cut material from the punch 34 received in the aperture 74 may be ejected through the ejection port 78.

As shown in FIG. 8, the ejection port 78 may be located on the outer circumferential surface of the tubular portion 76 of the punch 34, which allows cut material to be ejected laterally away from the punch 34. In other embodiments, the ejection port 78 may have other locations, for example, on the bottom of the punch 34.

The ejection port 78 of each punch 34 may be positioned and shaped to define a particular ejection path 80. As shown in FIG. 8, the ejection path 80 may slope downwardly away from the cutting aperture 74 (and generally towards the punch plate 52). The downward slope may help eject cut material from the punch 34.

As shown in FIG. 8, the ejection path 80 may slope downwardly at a downward ejection angle 82, which in this embodiment is about 135-degrees relative to the longitudinal axis L. In other embodiments, the downward ejection angle may be larger or smaller than 135-degrees.

In some embodiments, the ejection path 80 of each punch 34 may extend laterally away from a nearest adjacent punch, which may help to reduce clogging of cut material between the punches 34 on the perforation tile 32. For example, as shown in FIG. 9, the punches 34 may be arranged in a matrix with rows and columns (indicated by the axis R and the axis C, respectively), and the nearest adjacent punch may be an adjacent punch in a respective row R or column C. Furthermore, the ejection path 80 may extend toward an angularly positioned punch 34A that is further away than the nearest adjacent punch in a respective row R or column C. For example, as shown in FIG. 9, the ejection path 80 may extend toward an angularly positioned punch 34A that is offset from the respective punch 34 by at least one row and at least one column (or more particularly, by at least two columns). Ejecting cut material away from the nearest adjacent punch might better utilize available space on the perforation tile 32 for collecting cut material so as to reduce the frequency at which cut material is cleaned off of the perforation tile 32.

In some embodiments, the ejection path 80 may extend along an azimuthal ejection angle 84 of about 30-degrees relative to the respective column C of the punch 34. In other embodiments, the azimuthal ejection angle 84 may be larger or smaller than 30-degrees.

In some embodiments, the particular ejection path 80 and azimuthal ejection angle 84 may depend on spacing between adjacent punches 34. For example, when the punches 34 are spaced apart by a spacing distance S of about 3.5-millimeters, it may be desirable for the ejection path 80 to extend toward an angularly positioned punch 34A that is offset from the respective punch 34 by at least one row and at least two columns (as shown in FIG. 9).

In some embodiments, the ejection path 80 may extend along other directions. For example, the ejection path 80 may extend along a path selected to avoid as many punches as possible.

Referring again to FIG. 8, each punch 34 has a base portion 86 sized and shaped to be received within the apertures 58 of the punch plate 52. The base portion 86 may have a height H selected so that the ejection port 78 is located above the punch plate 52 by some clearance distance CD. The clearance distance CD may be selected to allow for some accumulation of cut material between punches 34.

For example, the clearance distance CD may be at least about 3 millimeters above the punch plate 52, or at least about 0.15-millimeters above the punch plate 52. In other embodiments, the clearance distance CD may be smaller than 0.15-millimeters.

In some embodiments, the apparatus 20 may include locating members for positioning and aligning the perforation tiles 32 on the tile holder 30. For example, as shown in FIG. 3, the locating members may include a set of datum members 90A, 90B and a set of locking clamps 92A, 92B aligned along opposing peripheral sides or edges of the tile holder 30. The locking clamps 92A, 92B are generally configured to selectively bias the perforation tiles 32 against the opposing datum members 90A, 90B.

More particularly, a first set of datum members 90A may be located along a first peripheral edge 100, and a first set of locking clamps 92A may be located along a second peripheral edge 102 that opposes the first peripheral edge 100. The first set of locking members 92A may bias rows of perforation tiles 32 against the opposing datum members 90A.

Furthermore, a second set of datum members 90B may be located along a third peripheral edge 104, and a second set of locking clamps 92B may be located along a fourth peripheral edge 106 that opposes the third peripheral edge 104. The second set of locking members 92B may bias columns of perforation tiles 32 against the opposing datum members 90B.

The datum members 90A, 90B may be rigid members extending outwardly away from the tile holder 30. For example, as shown in FIG. 3, the datum members 90A, 90B may include rigid locating dowels or posts extending upwardly from the tile receiving plate 42. Furthermore, the locating dowels may be spaced apart along the peripheral edges 100, 104 such that at least two locating dowels bear against each row/column of perforation tiles 32. Providing two or more locating dowels for each row/column of perforation tiles 32 may help maintain linear rows/columns. In contrast, a single locating dowel might allow the rows/columns of perforation tiles 32 to twist or become skewed.

In other embodiments, the datum members 90A, 90B may also have other configurations, such as a single linear ridge or vertically extending wall along each peripheral edge 100, 104.

The locking clamps 92A, 92B are generally configured to bias the perforation tiles 32 against the datum members 90A, 90B. As shown in FIG. 3, the locking clamps 92A, 92B may include eccentric members rotatably mounted to the tile holder 30. Furthermore, the eccentric members may be rotatable between a locked position for biasing the perforation tiles 32 against the datum members 90A, 90B and an unlocked position for arranging, rearranging, or replacing the perforation tiles 32. More particularly, the eccentric members may be hexagonal fasteners rotatatably mounted to the tile receiving plate 42 about an eccentric axis of rotation A. The eccentric axis of rotation A positions the six flat faces of the hexagonal fastener at different radial distances from the eccentric axis of rotation A. In the locked position, the radially outermost flat face of the hexagonal fastener can engage an adjacent perforation tile 32. In the unlocked position, the radially innermost flat face of the hexagonal fastener is spaced apart from an adjacent perforation tile 32.

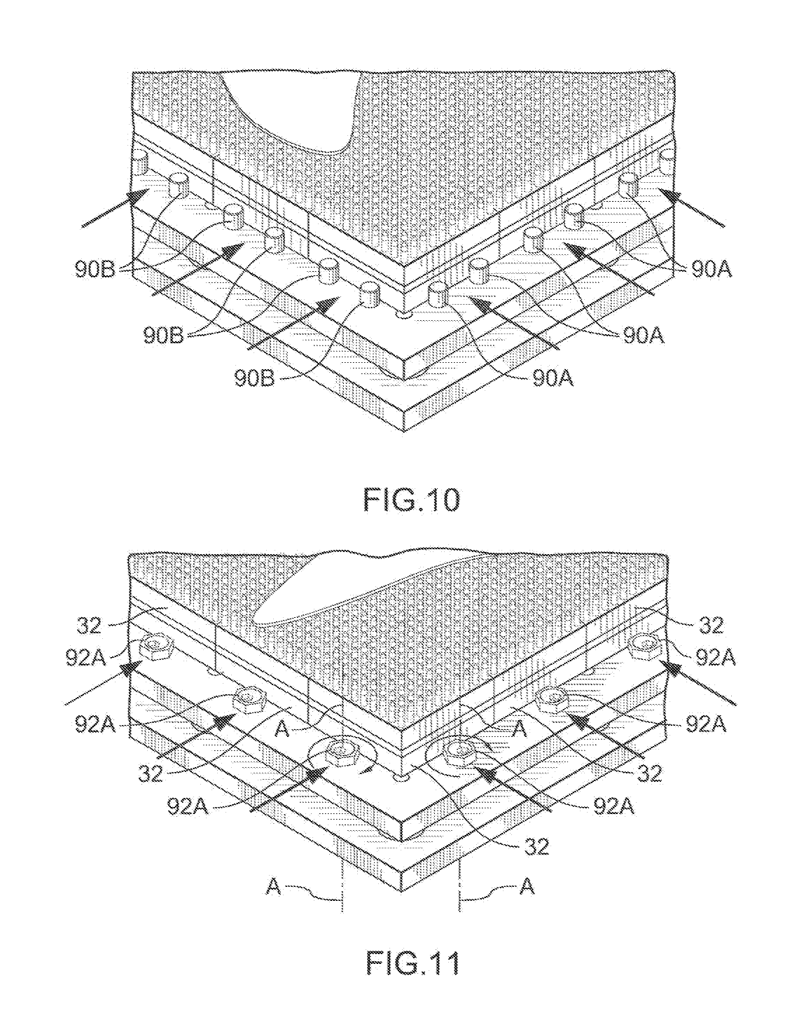

As shown in FIGS. 10 and 11, rotating the hexagonal fasteners about the eccentric axis of rotation A can cause the radially outermost flat face to bear against an adjacent perforation tile 32, and thereby bias that row/column of perforation tiles 32 toward the opposing datum members 90. This can help maintain the position and alignment of the perforation tiles 32 in their respective rows/columns.

As shown, there may be a single eccentric hexagonal fastener for bearing against each row/column of perforation tiles 32. In other embodiments, there may be more than one eccentric member per row/column of perforation tiles 32. Furthermore, while the illustrated embodiment includes eccentric hexagonal fasteners, in other embodiments, the eccentric members may have other shapes, such as square, circular, and so on.

In some embodiments, the datum members 90 and locking members 92 may provide enough force to hold the perforation tiles onto the tile holder 30 without the use of a separate fastener (e.g. without the threaded fasteners 48). In particular, the force applied along each row and column of perforation tiles 32 may provide a transverse frictional force that holds the perforation tiles 32 onto the tile holder 30, particularly where only a small number of perforation tiles 32 are being used.

In some embodiments, the locking members 92 may be biased to apply pressure against the perforation tiles 32, for example using a spring member.

In some embodiments, the apparatus 20 may also include other types of locating members for positioning and aligning the perforation tiles 32 on the tile holder 30. For example, with reference to FIGS. 4-7, each perforation tile 32 may include a locating projection 110 extending outwardly beyond the fastener plate 50 away from the punch plate 52. The locating projection 110 may be shaped to be received within a corresponding locating aperture 111 in the tile holder 30 (as shown in FIG. 3). As shown in FIG. 4, the locating projection 110 may be a cylindrical dowel that is sized and shaped to be received in a corresponding circular locating aperture 111 on the tile receiving plate 42. In other embodiments, the locating projection 110 and the locating aperture may have other shapes and configurations, such as square, rectangular, and so on.

The locating projection 110 is generally offset from the threaded aperture 56. For example, the threaded aperture 56 may be located approximately in the center of the perforation tile 32, and the locating projection 110 may be located off-center. Offsetting the threaded aperture 56 and the locating projection 110 sets the particular position and orientation that the perforation tiles 32 can be secured to the tile holder 30. In this sense, the cooperation of the locating projection 110 and the threaded aperture may provide a key for locating the perforation tiles 32 on the tile holder 30, and thus maintaining the position and orientation of the rows/columns of perforation tiles 32.

While the illustrated embodiment includes datum members 90, locking clamps 92, and locating projections 110 as the locating members, in some embodiments, the locating members may have other configurations. For example, the locating members may include springs that bias the perforation tiles 32 toward opposing datum members. As another example, the locating members may include grooves along the top of the tile receiving plate 42 for receiving corresponding ribs along the bottom of the perforation tiles 32.

In use, the perforation tiles 32 are arrangeable on the tile holder 30 such that the punches 34 define a perforation pattern. After arranging the perforation tiles 32 on the tile holder 30 in the desired perforation pattern, the sheet of material 22 may then be pressed onto the plurality of punches 34 so as to perforate the sheet 22 with that perforation pattern.

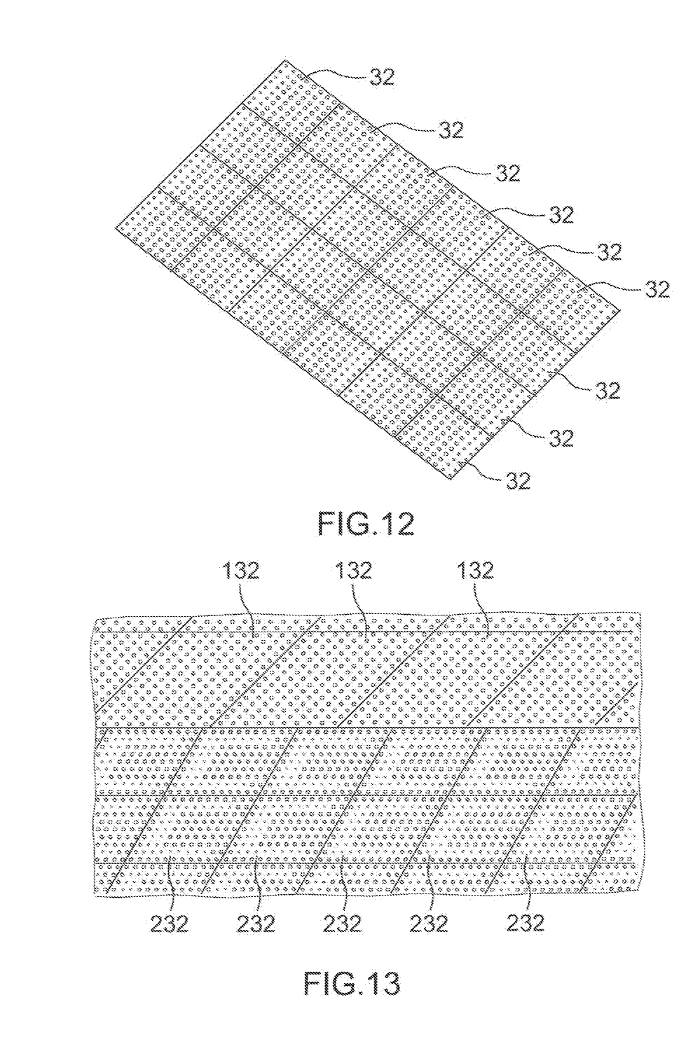

The perforation tiles 32 can also be exchanged or rearranged to provide different perforation patterns. For example, FIG. 12 shows a first arrangement of perforation tiles 32 so as to provide a first perforation pattern, and FIG. 13 shows a second arrangement of perforation tiles 132, 232 to provide a second perforation pattern.

As shown in FIG. 12, in some embodiments, each of the perforation tiles 32 may have a rectangular arrangement of punches, and furthermore, the perforation tiles 32 may be aligned with each other so as to provide a rectilinear perforation pattern.

As shown, some of the punches may have larger cutting apertures than other punches so as to provide a perforation pattern with perforations of different sizes even though the perforations are aligned in rows and columns. In other embodiments, the cutting apertures may be of the same size.

As shown in FIG. 12, the perforation tiles 32 may be of the same general type, size and shape. In other embodiments, the apparatus 20 may include different types of perforation tiles and each type of perforation tile may have a different size and shape so as to provide a particular perforation pattern. For example, as shown in FIG. 13, there may be two or more types of perforation tiles, namely a first type of perforation tile 132 and a second type of perforation tile 232. Both types of perforation tiles 132, 232 are shaped as parallelograms, however, the first type of perforation tile 132 is larger than the second type of perforation tile 232. Furthermore, the first type of perforation tile 132 has a steeper angle than the second type of perforation tile 232. In some examples, the perforation tiles may have other shapes, such as triangular, hexagonal, and so on.

In some embodiments, the perforation tiles may be sized and shaped so as to be arranged contiguously on the tile holder 30. In particular, adjacent perforation tiles in each row and column may be in contact with each other or share a common boundary as shown in FIGS. 12 and 13. Arranging the perforation tiles in this fashion may provide a continuous perforation pattern on the tile holder 30. In other embodiments, the perforation tiles may be spaced apart from each other.

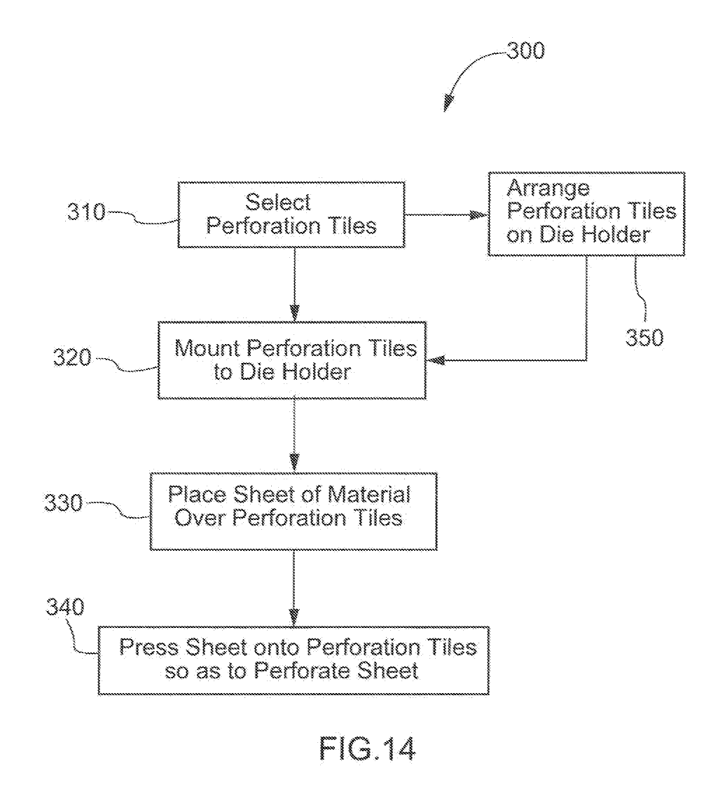

Referring now to FIG. 14, there is a method 300 of perforating a sheet of material such as a sheet of leather. The method includes steps 310, 320, 330, and 340.

Step 310 includes selecting a plurality of perforation tiles having one or more punches for perforating the sheet of material. For example, the perforation tiles may be the perforation tiles 32, 132 or 232 described above.

Step 320 includes mounting the selected perforation tiles to a tile holder, such as the tile holder 30. For example, the perforation tiles may be mounted to the tile holder using a number of techniques, such as using threaded fasteners as described above.

Step 330 includes placing the sheet of material over the mounted perforation tiles. For example, step 330 may include placing a sheet of leather on the perforation tiles. Step 330 may also include placing a cutting pad on top of the sheet of material, such as a polypropylene cutting pad.

Step 340 includes pressing the sheet of material onto the mounted perforation tiles so as to perforate the sheet of material. For example, step 340 may include pressing the sheet of material onto the perforation tile such that the punches of the perforation tiles perforate the sheet of material. In some examples, the sheet of material may be pressed onto the punches using a roller press or another press such as a platen press. In some examples, the cutting pad may be positioned between the sheet of material and the press (e.g. the roller press), which may protect the punches from being damaged.

After perforating the sheet of material, cut material may accumulate on the tile holder, for example, when the punches have ejection ports located on their sides. Accordingly, it may be desirable to clean or remove the cut material from the tile holder, for example, by vacuuming or blowing the cut material off the tile holder.

The method 300 may also include step 350 of arranging the selected perforation tiles on the tile holder so that the punches define a perforation pattern. Furthermore, pressing the sheet of material onto the mounted perforation tiles may perforate the sheet of material with the desired perforation pattern. The perforation pattern may be one of the perforation patterns shown FIG. 12 or 13, or may be another perforation pattern.

As shown in FIG. 14, step 350 of arranging the perforation tiles may occur after step 310 of selecting the perforation tiles. In some embodiments, step 350 may occur contemporaneously with step 320 of mounting the perforation tiles to the tile holder.

In some examples, a perforation template may be used to align the sheet of material on the punches. For example, the perforation template may be a sheet of plastic (e.g. Mylar) sized to fit over the punches of the perforation tiles. The perforation template may have an opening sized and shaped to correspond with the shape of the sheet of material to be perforated. The opening may aid in positioning the sheet of material on the punches. This can help align the perforation pattern with respect to the sheet of material, for example, so that successive perforated sheets of material have substantially similar perforations therein with respect to the location, orientation, and design of the perforation pattern.

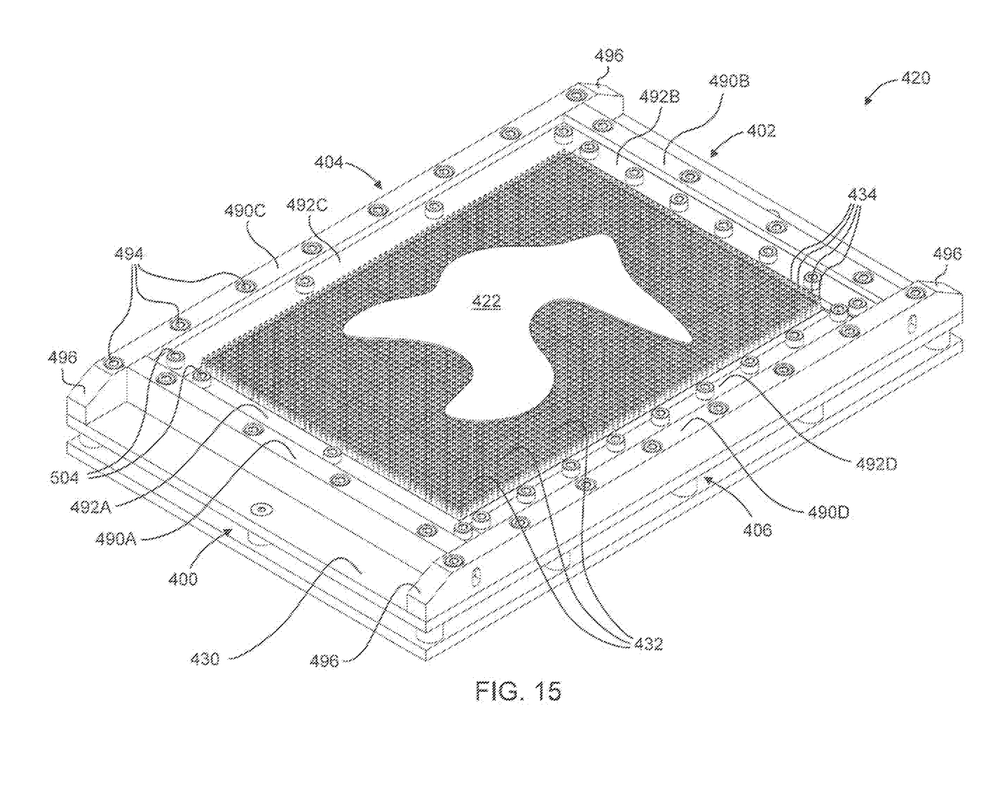

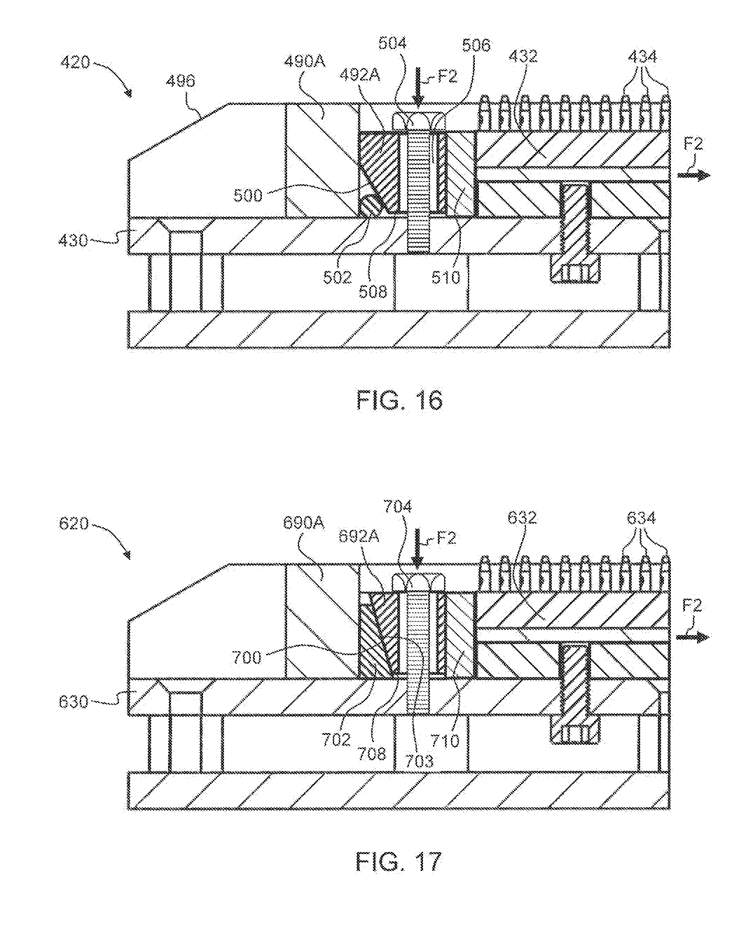

Referring now to FIGS. 15 and 16, there is another apparatus 420 for perforating a sheet of material 422, such as a sheet of leather, according to some embodiments. The apparatus 420 is similar in many respects to the apparatus 20 and similar elements are given similar reference numerals incremented by four hundred. For example, the apparatus 420 includes a tile holder 430 and a plurality of perforation tiles 432 having one or more punches 434.

The apparatus 420 includes one or more locating members for positioning and aligning one or more perforation tiles 432 on the tile holder 430. As shown, the locating members include elongate alignment members 490A, 490B, 490C, 490D mounted along the peripheral sides or edges of the tile holder 430. The alignment members 490A, 490B, 490C, 490D generally extend upwardly from the tile holder 430 to form an outer perimeter or border along the edges of the tile holder 430, within which the perforation tiles 432 are mounted. The locating members also include biasing members 492A, 492B, 492C, 492D located between the alignment members 490A, 490B, 490C, 490D and the perforation tiles 432. For example, the biasing members 492A, 492B, 492C, 492D may extend along corresponding alignment members 490A, 490B, 490C, 490D so as to form an inner border between the alignment members 490A, 490B, 490C, 490D and the perforation tiles 432. The biasing members 492A, 492B, 492C, 492D generally press or bias the perforation tiles 432 into a particular position and alignment, for example, by biasing the perforation tiles towards an opposing one of the alignment members.

The alignment members 490A, 490B, 490C, 490D may extend along respective sides or edges of the tile holder 430. For example, as shown in FIG. 15, there are first and second alignment members 490A, 490B extending along opposing first and second peripheral edges 400, 402, and there are third and fourth alignment members 490C, 490D extending along opposing third and fourth peripheral edges 404, 406. The first and second alignment members 490A, 490B may be generally transverse or orthogonal to the third and fourth alignment members 490C, 490D.

The alignment members 490A, 490B, 490C, 490D are generally mounted to the tile holder 430. In some examples, the alignment members 490A, 490B, 490C, 490D may be separate pieces secured to the tile holder 430, for example, using bolts 494 or other fasteners such as adhesives, welds, and so on. In some examples, the alignment members 490A, 490B, 490C, 490D may be integrally formed with the tile holder 430.

As shown in FIG. 15, the third and fourth alignment members 490C, 490D may have opposing ends with sloped or ramped surfaces 496. The sloped ends may provide a lead-in section, for example, so that the apparatus 420 can be gradually fed into a roller press. As shown in FIG. 16, the punches 434 generally have a height selected so that the cutting edges thereof are located above the alignment members 490A, 490B, 490C, 490D and the biasing members 492A, 492B, 492C, 492D.

Referring now to FIG. 16, one of the biasing members 492A will be described in greater detail. As shown, the biasing members 492A may be positioned between the alignment member 490A and the perforation tile 432. Furthermore, the biasing members 492A may have a generally wedge-like shape, for example, with a sloped surface 500 shaped to engage a corresponding bearing element 502, which may be positioned between the alignment member 490A and the biasing members 492A. The sloped surface 500 and the bearing element 502 are generally shaped so that pressing the biasing members 492A onto the bearing element 502 with a first or downward force F1 generates a second or lateral force F2 that urges one or more perforation tiles 432 into a particular position or alignment on the tile holder 430. For example, the bearing element 502 may be formed as a cylindrical element, which can allow the biasing member 492A to shift laterally toward the perforation tile 432 as it slides downward toward the tile holder 430.

The downward force F1 may be generated, for example, using a threaded fastener 504 that extends through the biasing member 492A and into the tile holder 430. Threading the fastener 504 into the tile holder 430 may press the biasing member 492A downward so that the sloped surface 500 engages the bearing element 502 and generates the lateral force F2.

In some examples, the biasing member 492A may have an opening 506 with a diameter that is larger than the diameter of the threaded fastener 504. This can provide clearance for allowing lateral movement of the biasing member 492A, for example, so that the biasing member 492A shifts laterally toward the perforation tile 432 as the biasing member 492A is pressed downward toward the tile holder 430.

There may also be a gap between a bottom side 506 of the biasing member 492A and the tile holder 430. The gap can allow some excess clearance, for example, to ensure that the biasing member 492A shifts a sufficient distance toward the perforation tile 432 so as to position or align the perforation tiles 432 on the tile holder 430.

As shown, the apparatus 420 may also include an intermediate member 510 between the biasing member 492A and the perforation tile 432. The intermediate member 510 can help provide a flat surface for straightening or aligning the perforation tiles 432.

While the example illustrated in FIG. 16 includes a threaded fastener 504, in other examples, the downward force F1 could also be generated using other mechanisms, such as springs, clamps, and so on.

While the bearing element 502 shown in FIG. 16 is a separate piece. In some examples, the bearing element 502 may be integrally formed as part of the alignment member 490A, the intermediate member 510 or the perforation tile 432. The bearing element 502 could also have other shapes and configurations, for example, such as a wedge-like shape as shown in FIG. 17.

While the example illustrated in FIG. 15 includes four biasing members 492A, 492B, 492C, 492D, in some examples, there may be one or more biasing members 492A, 492B, 492C, 492D. For example, the apparatus 420 may include the first and second alignment members 490A, 490B and only one biasing member 492A.

Referring now to FIG. 17 there is another apparatus 620 for perforating a sheet of material. The apparatus 620 is similar in many respects to the apparatus 420 and similar elements are given similar reference numerals incremented by two hundred. For example, the apparatus 620 includes a tile holder 630, a plurality of perforation tiles (only one perforation tile 632 is shown) having one or more punches 634, one or more alignment members 690A, one or more biasing members 692A, and one or more bearing elements 702.

As shown, the biasing member 692A may have a generally wedge-like shape with a first sloped surface 700, which may be similar to the shape of the biasing member 492A. Furthermore, the bearing element 602 may also have a corresponding wedge-like shape with a corresponding sloped surface 703. The sloped surfaces 700, 703 are generally shaped so that pressing the biasing members 692A onto the bearing element 702 with a first or downward force F1 (e.g. using a threaded fastener 704) generates a corresponding second or lateral force F2 that urges one or more perforation tiles 432 into a particular position and alignment (e.g. through the intermediate member 710).

The apparatus and methods described herein allow quick changeover of perforation tiles on a tile holder. This can be particularly useful when repairing one or more broken punches. For example, if a punch on a perforation tile breaks, the damaged perforation tile can be removed from the tile holder and a replacement perforation tile can be mounted in its place without replacing the entire lower plate. The use of replacement perforation tiles can be less expensive than conventional replacement perforation dies, in which all of the punches are secured to a single lower plate. Furthermore, the use of the perforation tiles can allow faster repairs in comparison to conventional perforation dies, and can reduce manual labor associated with removing the entire perforation die during maintenance.

The perforation tiles also enable a variety of reconfigurable perforation patterns. This can be particularly useful when different products have a custom logo, yet similar perforation patterns around or adjacent to the custom logo. This is often the case for leather car seat upholstery. In these circumstances, different custom perforation tiles may be manufactured for the customized logo, while another set of standard perforation tiles may be used for a particular perforation pattern around or adjacent to the custom logo.

Although embodiments herein have referred to cutting tiles having one or more punches for perforating sheets of material, it will be appreciated that in other embodiments, a perforation tile may include one or more cutting knives that may be sized and shaped to cut other patterns. In particular, a perforation tile with a cutting knife may be sized and shaped to remove a continuous amount of material according to a desired pattern, for example for cutting an opening in a sheet of leather.

While the above description provides examples of one or more apparatus, methods, or systems, it will be appreciated that other apparatus, methods, or systems may be within the scope of the present description as interpreted by one of skill in the art.

1. An apparatus for perforating a sheet of material, the apparatus comprising:
(a) a tile holder; and
(b) a plurality of perforation tiles removably mountable to the tile holder, each perforation tile including:
(i) a fastener plate for removably mounting the perforation tile to the tile holder;
(ii) a punch plate supported by the fastener plate opposite the tile holder, the punch plate having at least one aperture therein;
(iii) at least one punch received in the at least one aperture and extending outwardly beyond the punch plate away from the fastener plate for perforating the sheet of material; and
(iv) a backing plate positioned between the fastener plate and the punch plate for supporting the at least one punch;
(c) the tile holder further including a plurality of mounting apertures for removably mounting the plurality of perforation tiles to the tile holder.
(d) the fastener plate of each perforation tile having a threaded aperture for receiving a corresponding threaded fastener so as to threadably fasten the perforation tile to the tile holder through one of the mounting apertures, each threaded aperture extending entirely through the fastener plate.

2. An apparatus for perforating a sheet of material, the apparatus comprising:
(a) a tile holder; and
(b) a plurality of perforation tiles removably mountable to the tile holder, each perforation tile including:
(i) a fastener plate for removably mounting the perforation tile to the tile holder;
(ii) a punch plate supported by the fastener plate opposite the tile holder, the punch plate having at least one aperture therein; and
(iii) at least one punch received in the at least one aperture and extending outwardly beyond the punch plate away from the fastener plate for perforating the sheet of material.

3. The apparatus of claim 2, wherein each perforation tile further includes a backing plate positioned between the fastener plate and the punch plate for supporting the at least one punch.

4. The apparatus of claim 2 or claim 3, wherein the tile holder includes a plurality of mounting apertures for removably mounting the plurality of perforation tiles to the tile holder.

5. The apparatus of claim 4, wherein the fastener plate of each perforation tile has a threaded aperture for receiving a corresponding threaded fastener so as to threadably fasten the perforation tile to the tile holder through one of the mounting apertures.

6. The apparatus of claim 5, wherein each perforation tile further includes a backing plate positioned between the fastener plate and the punch plate for supporting the at least one punch, and wherein the threaded aperture extends entirely through the fastener plate.

7. The apparatus of any one of claims 1 to 6, wherein the tile holder includes a bolster plate and a tile receiving plate spaced apart from the bolster plate.

8. The apparatus of any one of claims 1 to 7, wherein each punch has:
(a) a tip portion with a cutting edge for perforating the sheet of material;
(b) a cutting aperture on the tip portion for receiving cut material; and
(c) an ejection port located on a side of the punch, the ejection port being in communication with the cutting aperture for ejecting the cut material from the punch.

9. The apparatus of claim 8, wherein the ejection port is positioned and shaped to provide an ejection path that slopes downwardly away from the cutting aperture.

10. The apparatus of claim 8 or 9, wherein the at least one punch includes a plurality of punches, and wherein the ejection port is positioned and shaped to provide an ejection path that extends laterally away from a nearest adjacent punch.

11. The apparatus of claim 10, wherein the plurality of punches are arranged in a matrix of rows and columns such that the nearest adjacent punch is an adjacent punch in a respective row.

12. The apparatus of claim 11, wherein the ejection path of each punch extends toward an angularly positioned punch that is offset from the respective punch by at least one row and at least one column.

13. The apparatus of any one of claims 1 to 12, further comprising locating members for positioning and aligning the plurality of perforation tiles on the tile holder.

14. The apparatus of claim 13, wherein the tile holder includes opposed peripheral edges, and wherein the locating members include:
(a) a set of datum members along one peripheral edge, and
(b) a set of locking clamps along the opposing peripheral edge for selectively biasing the perforation tiles towards the opposing datum members.

15. The apparatus of claim 14, wherein the locking clamps include eccentric members rotatably mounted to the tile holder about an eccentric axis of rotation.

16. The apparatus of claim any one of claims 13 to 15, wherein the tile holder includes opposed peripheral edges, and wherein the locating members include:
(a) a first alignment member mounted along one peripheral edge;
(b) a second alignment member mounted along the opposing peripheral edge; and
(c) at least one biasing member located between the first alignment member and at least one perforation tile for biasing the perforation tiles towards the second alignment member.

17. The apparatus of any one of claims 1 to 16, wherein the plurality of perforation tiles are arrangeable on the tile holder to define a perforation pattern.

18. A perforation tile removably mountable to a tile holder for perforating a sheet of material, the perforation tile comprising:
(a) a fastener plate for removably mounting the perforation tile to the tile holder;
(b) a punch plate supported by the fastener plate opposite the tile holder, the punch plate having at least one aperture therein; and
(c) at least one punch received in the at least one aperture and extending outwardly beyond the punch plate away from the fastener plate for perforating the sheet of material.

19. The perforation tile of claim 18, further comprising a backing plate positioned between the fastener plate and the punch plate for supporting the at least one punch.

20. The perforation tile of claim 18 or 19, wherein the fastener plate has a threaded aperture for receiving a corresponding threaded fastener so as to threadably fasten the perforation tile to the tile holder.

21. A method of perforating a sheet of material, the method comprising:
(a) selecting a plurality of perforation tiles having a at least one punch for perforating the sheet of material;
(b) mounting the selected perforation tiles to a tile holder;
(c) placing the sheet of material over the mounted perforation tiles; and
(d) pressing the sheet of material onto the mounted perforation tiles so as to perforate the sheet of material.

22. The method of claim 21, further comprising arranging the selected perforation tiles on the tile holder such that the plurality of perforation tiles define a perforation pattern, and wherein pressing the sheet of material onto the mounted perforation tiles perforates the sheet of material with the perforation pattern.
